(19) United States
(12) Patent Application Publication
(10) Pub. No.: US 2021/0148334 A1
(43) Pub. Date: May 20, 2021

(54) ISOLATED WIND TURBINES

(71) Applicant: Maha Taleb ALSADUN, Ar Riyadh (SA)

(72) Inventor: Maha Taleb ALSADUN, Ar Riyadh (SA)

(21) Appl. No.: 17/021,255

(22) Filed: Sep. 15, 2020

(30) Foreign Application Priority Data
Nov. 16, 2019 (SA) 119410210

(51) Int. Cl. F03D 9/30; F03D 1/04; F03D 13/20

(52) U.S. Cl. CPC F03D 9/30; F03D 13/20; F03D 1/04

(57) ABSTRACT

The invention is directed to wind turbines operating inside (closed) buildings. These isolated turbines are operated by (naturally) pumping the wind from one side of a building and (mechanically) expelling it from the other side by means of (suction) fans. Alternatively, the turbines can be operated by (mechanically) pumping wind from one side of a building and (mechanically) expelling it from the other side by (suction) pumps that withdraw wind from the building and expel it continually generating a strong air stream in the building having the required velocity for actuating the turbines efficiently. Many adjacent buildings can be constructed, wherein they are connected to each other by tubes that may allow easy transfer of the wind from a building to another. It is only the first building that (naturally or mechanically) receives (natural or mechanical) wind. The last building's fans suck wind and expel it outside generating a strong air stream in all buildings that runs all turbines at the same time and with the same operating capacity.

The invention aims at actuating wind turbines inside (closed) buildings using (natural/mechanical) winds whose velocity can be controlled and the electricity production can be increased. The invention also aims at solving the current problems of wind turbines such as: audiovisual noise, birds killing, the need for speedy and steady wind, and the high cost of building tower to reach the required wind velocity. The present invention provides turbines with the required wind inside closed buildings with the required velocity.

### TECHNICAL FIELD

The disclosure relates to wind turbines distributed within closed buildings above/under ground. They are operated by (naturally/mechanically) pumping wind from one side of a building and withdrawing it from the other side. Thus, a strong air stream will be generated whereby turbines can be efficiently run, and as a result electricity will be generated.

### BACKGROUND

Owing to the high cost of establishing high towers for wind turbines in the open air and because air turbines may kill birds and make non-stop audiovisual noise without having an ever-steady wind velocity, the present invention aims at getting rid of all these drawbacks. It allows fixing wind turbines within closed above/underground buildings with no need to such high towers to reach the required air velocity. Furthermore, the present invention provides such a velocity inside a building. It is also characterized by operating turbines within closed buildings using the energy of natural mild wind as this can double the strength and the velocity of natural mild wind within a building. The wind is contained then pumped into the turbines of the closed building so that the wind enters from one side of the building and exits from the other side forming a strong stream that drives turbines. Providing the building exit openings with fans that withdraw and expel the wind outside can reduplicate the wind strength and velocity within the building.

In other words, the greater the number of mounts that direct wind in a building and of the fans withdrawing wind from the building to the fresh air, the speeder the wind becomes until it reaches the required maximum velocity. Moreover, the present invention enables the construction of successive and unlimited closed buildings that are interconnected. Each building includes a field having a proper number of turbines. The wind is (naturally or mechanically) pumped only from the first building and (mechanically) withdrawn from the last building. This generates a strong air stream whose strength and velocity can be controlled to run the turbines efficiently.

### RELATED ART

There is no related art because all current wind turbines are operated outdoors and upon heights proper to the required production rate, whereas in the present invention turbines are fixed inside closed buildings.

### SUMMARY

The invention relates to indoor turbines. Buildings are either above or under the ground. A building contains a field having a proper number of wind turbines (at least one big turbine). The turbines in this field are operated in two ways:

Firstly: A number of wind mounts are deployed against wind in potential work places (wind turbine fields). Natural wind enters the mounts and is directed to (naturally) enter the turbine building from one side and (mechanically) exit from the other side by means of big suction fans. The wind movement between the two sides results in a continuous steady air stream that runs the turbines continuously. The wind velocity within the building is multiplied by increasing the number of wind receiving mounts as well as the number of suction fans that, when operated, strongly draw the wind from the building and expel it in the fresh air. The multiplication of wind velocity leads, as a result, to reduplicating turbine production.

Building turbines can be (mechanically) wind operated with no need to equip a building with wind mounts. In such a case, a closed building may be provided from one side with entry slots having high-power propeller fans, and, from the other side, with exit slots having strong suction fans. On operating the propeller fans, they (mechanically) pump wind into the building and at same time, the wind is (mechanically) drawn from the building. Thus an air stream will be created and run the turbines.

Accordingly, there are two embodiments for operating turbines in the buildings. The may work individually or in combination.

The first embodiment components as shown in FIG. 1:
Wind mount (1) with suitable size and number. They are used for containing natural outdoor wind.
Tubing (2) with the rate of (at least) one tube/a mount that is used to transfer natural wind from the mounts to the building of turbine field.
The building of turbine field (3) having proper dimensions used as a closed building in which wind turbines exist.
Wind (at least one) turbines (4) within the building used for generating electricity.
Pipes (5) for discharging wind out of turbine field building into the fresh air.
Fans (6) in the pipes (5) for sucking and drawing the wind from the pipes and expel them outside forming a strong and continuous air steam and regulating the wind inside the building.
wherein when the wind mounts are mounted outdoors, especially where wind velocity is mild (4-8 m/s), the wind (naturally) enters the mounts face steadily and rushes into the tubing that transfer it to the building of turbine field. It enters (naturally) from one side of the building and exit (mechanically) from the other side in a steady manner. A strong air stream is formed whose velocity is directly proportional to the number of mounts and drawing fans. Thus, the velocity of the wind inside the building can be (exponentially) reduplicated by increasing the number of suction and discharge fans. In case the wind velocity increases within the building, the wind can run the turbines much more powerfully than the turbines outdoors. Studies indicate that duplicating wind velocity increases turbine power 8 times.

The Second embodiment components as shown in FIG. 2:
The building of turbine field (1) having proper dimensions that is used as a closed building in which there is a plurality of wind turbines.
Tubing/openings (2) used to allow wind from the fresh air enter the turbine building.
High-capacity propeller fans (3) fixed in the entry openings and used for drawing wind from the fresh air and pump it (mechanically) into the building.
Wind turbines (4) within the turbine building with defined capacity (at least one turbine) used for generating electricity.
Exit tubing/openings (5) used for discharging wind from the building to the fresh air.
Fans (6) in the pipes (5) for sucking and drawing the wind from the pipes and expel them outside forming a strong and continuous air steam and regulating the wind inside the building.
Wherein upon operating propeller fans (3), they suck winds present in the fresh air via the tubing (2) and pump them (mechanically) into the building (1). The wind rotates the turbines (4) and exit from exit openings (5) outside the building. This results in a steady and speedy air stream that run the turbines continuously and generates electricity. Wind velocity can be controlled by increasing the number and capacity of suction fans. If wind velocity increases, production will increase several times.

The above-mentioned embodiments can establish successive and unlimited closed buildings (as shown in FIG. 3). Such buildings are interconnected by tubing that connects each building with the next one. Each building includes a field having a suitable number of turbines. (Only) the first building is attached with wind receiving mounts. Exit openings (only) in the last building are provided with strong suction fans. On operating the propeller fans, they (mechanically) pump wind into the building and at same time, they mechanically draw wind from all buildings (continuously). Thus, the wind enters the first building naturally and goes (steadily) to the last one wherefrom it exits (mechanically). An air stream will be created and run all turbines in the buildings simultaneously with the same operation capacity.

The two embodiments of the invention overcome the following problems facing the existing wind turbines:

1—The existing turbines need high towers to reach a proper air velocity. However, the invention can secure fast wind within a closed building without the need to build high towers.

2—The invention eliminates the cost of building high towers.

3—It confines noise to isolated building so that nobody is audio-visually harmed.

4—It protects birds against fins rotation.

5—The required wind velocity for turbines capacity can be obtained so that user can control the velocity of the wind entering turbine building by controlling the number of from one end and the number of suction fans from the other end. The greater the number of exhaust fans, the greater the amount, force and velocity of wind within a building in a direct proportion.

6—Turbines are protected from dust, rain, humidity. This extends its life span.

7—Breakdown maintenance is easy and on the ground.

8—It protects turbines from dust, dirt, rain and moisture, extending their service life.

9—It solves the problems of external fields, wherein adjacent turbines are influenced by wind distribution. That is some of turbines get winds at the required velocity, while neighboring turbines do not. Thus, this invention encourages field owners to isolate the turbines in closed buildings that allow control of the quantity, strength and velocity of the wind inside the closed building.

### Beneficial Effects of the Invention

1—Expanding the use of wind energy as an environmentally friendly natural energy.

2—Reducing the cost of wind energy generation.

3—Doubling the generation of electricity by increasing the wind velocity inside the building.

### DRAWING DESCRIPTION

FIG. 1—General perspective of the first embodiment wherein wind mounts are outdoors and mounted on the ground against the wind. The mounts hold natural wind and send it to the closed turbine building. The wind enters from one side of the building and exits from the other side which is provided with suction fans that pull the wind out of the building and expel it to the outside, creating a strong air stream that actuates the turbines.

FIG. 2—A general perspective of the second embodiment consisting of a closed building with entry openings equipped with fans that push winds into the building from one side and discharge it from the other side with the help of suction fans so that a fast and continuous air flow is formed to actuate the turbines.

FIG. 3—Several closed buildings are connected to each other by tubing that allows winds to exit from one building to the next one. It is noted that at the top the wind is pumped (mechanically) into the closed building and exits the building (mechanically). At the bottom of the figure, wind is (naturally) pumped into the building by the mounts and get out of the building (mechanically)

### INDUSTRIAL APPLICABILITY

The invention aims to benefit from the energy of mild natural winds, especially where wind turbine fields can be deployed and where it is possible to drive (small or medium) turbines in the open air. These mild winds are drawn and pumped into a closed building. The velocity and strength of these winds actuate turbines with higher capacities compared to the turbines managed by mild wind outside the building. This may redouble the production. The means of implementing the invention are as follows:

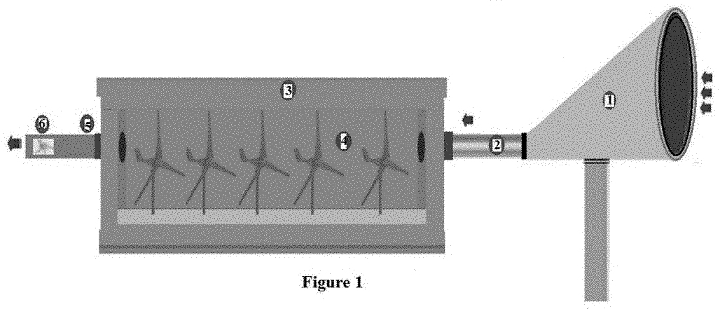

Means of Implementing the First Embodiment as Shown in FIG. 1:
Installing (1) iron mounts raised on strong poles to a suitable outdoors in places (candidated for deploying wind turbine fields) where the wind velocity in such fields are often ranging between (4-8 m/second). Such mounts have large nozzles at the front which gradually become smaller ending with a large iron pipe. The size, dimensions and capacity of the mounts are determined by technical calculations and mathematical equations so that they hold the largest possible amount of winds per second. The mounts' nozzles can be movable and rotatable around an axis and attached to sensors that make the nozzles always face the wind.
Pipes (2) of iron, steel or concrete; each pipe is attached to the cavity end of each mount. This pipe is used to transfer natural winds from the wind mount to the wind turbine building.
The building of the turbine field (3) that is made of iron, concrete, or any other building material. This building is closed and the wind coming from the mounts enters it (naturally) and exits from its other side mechanically. A continuous air stream is formed inside it that drives the turbines fins. It is to be noted that the more mounts the greater the velocity and strength of the wind inside the turbine building. The many mounts will act as natural fans that pump strongly natural air into the turbines building in direct proportion to their number.
Wind turbines (4) are installed inside the closed turbine field building. Their number (at least one turbine) is suitable for wind energy inside the building. They are distributed in the building in specific positions determined by technical calculations and with capacities suitable for wind energy inside the building. The technical distribution should take into account the influence of air pathways inside the building so that the wind is evenly distributed to turbines.
Tubing/openings (5) at the far end of the building allowing the wind that has entered the building to (naturally or mechanically) exit, so a continuous air stream is formed that runs the turbines continuously.
Suction fans (6) are installed inside the exit openings in the pipes (5). They should be technically appropriate using accurate calculations so that the force of drawing the wind pulling from inside the building and discharging it outside the building has a direct relationship to the rate of the wind velocity inside the building. In other words, the wind velocity inside the building is equal to the rate of wind charging outside it, so that the wind velocity inside the building can be controlled by changing the number of suction fans. Technical matters can be precisely considered for implementing the invention.

The Way the First Embodiment Works, as Shown in FIG. 1:

The mounts (1) facing the wind receives it from the fresh air. Then, the wind enters the mounts (naturally), and from there it travels through the tubing (2) to the turbine building (3) uninterruptedly. The incoming wind actuates the turbines (4) and exits from the end of the building (mechanically) by means of suction fans (5) that expel the wind out through the tubing (6) continuously.

As the wind continues to naturally enter and mechanically exit the building, a strong air stream is generated, which drives the turbines and generates electricity.

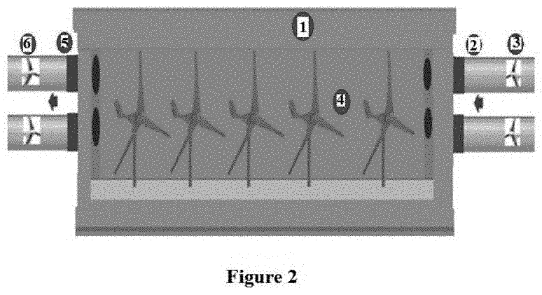

Means of Implementing the Second Embodiment as Shown in FIG. 2:
The building of the turbine field (1) that is made of iron, concrete, or any other building material. This building is closed and the wind enters it by means of tubing or openings in one side, wherein the wind is mechanically introduced by propeller fans and mechanically discharged from the other side. A continuous air stream is formed that drives the turbines fins. It is to be noted that the greater the number of mounts the greater the velocity and strength of the wind inside the turbine building.
Large tubing or openings (2). The pipe opening outside the building is large and has a diameter that is accurately calculated. It is installed in one side of the building wherein it is used to introduce the wind into the building at the required velocity and amount.
Propeller fans (3) with high capacities (such as large tunnel fans). They are installed inside wind entry openings/tubes and are used to draw wind from the fresh air and pump it mechanically into the building with high capacities for rapid pumping that is measured in meters per second.
Wind turbines (4) are installed inside the closed turbine field building. Their number is suitable for the wind energy inside the building. They are distributed in the building in specific positions determined by technical calculations and with capacities suitable for the wind energy inside the building. The technical distribution should take into account the influence of air pathways inside the building so that the wind is evenly distributed to turbines.
Tubing/openings (5) at the far end of the building allowing the wind that has mechanically entered the building to exit uninterruptedly, so a continuous air stream is formed that runs the turbines continuously.
Suction fans (6) are installed inside the exit openings in the pipes (5). They should be technically appropriate using accurate calculations so that the force of drawing the wind pulling from inside the building and discharging it has a direct relationship to the rate of the wind velocity inside the building. Technical matters can be precisely considered for implementing the invention.

The Way the First Embodiment Works, as Shown in FIG. 2:
The fans (3) mechanically pump the wind to the turbine building (1) continuously via the tubing (2). The incoming wind runs the turbines (4) and (mechanically) exits the end of the building by means of suction fans (5) that expel the wind outside through the pipes (6) uninterruptedly. As the wind continues to mechanically enter and exit the closed building, a strong air stream is generated actuating the turbines and generating electricity.

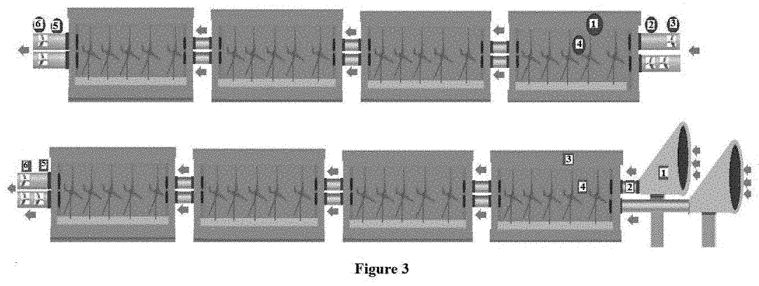

Means of Improving the Performance of the Two Embodiments as Shown in FIG. 3:

A successive and unlimited number of closed buildings can be established. Such successive buildings are adjacent and connected to each other by tubing interconnecting each building to the next one. Each building includes a field having an appropriate number of turbines. The wind is (mechanically or naturally) pumped only into the first building and is (mechanically) withdrawn only from the last building, generating a strong and fast air stream (whose strength and velocity can be controlled) in all buildings. The stream it runs all the turbines in every buildings at the same time, with high efficiency and with the same operating capacity.

1- Wind turbines operating within closed buildings used to generate electricity; these turbines are operated and rotated by the energy of (natural wind) present in the fresh air, wherein this wind is contained and withdrawn from the fresh air by pole-raised mounts whose nozzles are at a technically appropriate height above the ground and move automatically via sensors so that they are always facing the winds; wherein the wind enters the mounts and are propelled into the tubing attached to their ends, then the tubing transfers it to the (closed turbine field) building; the wind (naturally) enters from one side of the building and (mechanically) exits from the other though tubing equipped with suction (discharge) fans that draw wind from the building and expel it continuously; thus air velocity is increased and drives the turbines that generate electricity efficiently. The wind velocity inside the closed building is directly proportional to the number of suction fans and the amount of wind withdrawn from the building; therefore, the greater their number, the greater the velocity of the wind inside the building becomes. Many adjacent executive buildings can be constructed, wherein each building can be equipped with a plurality of tubes connecting it to the other building next to it and allows air to pass from one building to another uninterruptedly. Only the first building is the one that receives the wind (naturally) and the last building is the one from which the winds exit (mechanically), wherein an air stream is generated in all buildings and actuates the turbines at the same time with the same operating capacity. The invention, as shown in FIG. 1, includes:
Pole-raised wind mounts (1) made of iron at an appropriate height and installed against the wind in the possible positions (for wind turbine fields); the number of these mounts is technically calculated to collect the largest possible amount of winds per second; these mounts are used to contain natural winds present in the fresh air, and then direct them to the (closed) turbine field building.
Tubing (2), with at least one tube at the end of each mount used to transfer wind from a mount to the turbine field building.
Turbine field building (3): a closed building with a technically appropriate size and height. It is built above or under the ground and is used to isolate several wind turbines therein; it receives natural winds from one side and the wind mechanically exits from the other side, forming an air stream that drives the turbines.
Wind turbines (4) used to generate electricity, installed in a field within the closed building, with a technically appropriate number (at least one) and with suitable capacities. These turbines are driven by natural winds entering from one side of the building and exiting from the other side.
Openings or tubing (5) used for the mechanical wind exit from the turbine field building in an uninterrupted way.
Suction fans (6) inside the wind exit tubing (5) that are used to suction and draw the wind from the building and expel it outside continuously, thus doubling the wind velocity and energy inside the building.

2- Wind turbines operating inside closed buildings used to generate electricity. These turbines are powered and driven by the energy of natural wind present in the fresh air, wherein the wind is (mechanically) contained and drawn from the fresh air by huge fans that pump it into the building, and the wind exits (mechanically) from the other side of the building by pipes provided with suction (discharge) fans that draw the wind from the building and expel it outside continuously, thus increasing the air velocity inside the building, driving the turbines and generating electricity efficiently. The wind velocity inside the closed building is directly proportional to the number of suction fans and the amount of wind drawn from the building, so the greater their number, the greater the wind velocity inside the building becomes; this module is distinguished by the fact that several adjacent buildings can be constructed in succession, and each building is provided with several tubing connecting it to the next building and allowing the passage of air from one building to another uninterruptedly, wherein only the first building is the one that receives the wind (mechanically) and the last building is the one from which the winds (mechanically) exit; wherein an air stream is generated in all buildings and actuates the turbines simultaneously and with same operating capacity. The invention as shown in FIG. 2) includes:
Turbine field building (1) used to isolate the turbines therein. This building is a closed one with a technically appropriate size and height, and constructed above or under the ground, and (mechanically) receives the wind that is pumped by propeller fans from one side and (mechanically) exits from the other side by means of powerful suction fans, so a strong air stream that rotates the turbines is formed.
Tubing (2) in one side of the enclosed building used for introducing wind from the fresh air into the turbine field building
Fans (3) within (the tubing/pipes) used to draw wind from the fresh air and pump it into the closed building.
Wind turbines (4) used to generate electricity; these turbines are installed and distributed in the closed building, according to technical calculations, in a technically appropriate number, and with appropriate capacities. they are rotated by winds entering from one side of the building and exiting from the other side.
Openings or pipes (5) used for exiting wind from the turbine field building.
Suction fans (6) installed inside the exit openings and used to draw wind from inside the building and expel it outside in order to form a fast air stream inside the building that actuates the turbines.
